(19) United States
(12) Patent Application Publication
(10) Pub. No.: US 2003/0194572 A1
(43) Pub. Date: Oct. 16, 2003

(54) Textured clear coated lighting sheet

(76) Inventors: Leighton M. Cooper, Lancaster, PA (US); Charles H. Smuck, Lancaster, PA (US); Daniel L. Serafin, Wexford, PA (US); Robert E. Bombalski, New Kensington, PA (US)

Correspondence Address: ALCOA INC, ALCOA TECHNICAL CENTER, 100 TECHNICAL DRIVE, ALCOA CENTER, PA, 15069-0001, US

(21) Appl. No.: 10/123,572

(22) Filed: Apr. 16, 2002

(51) Int. Cl. B32B 15/04

(52) U.S. Cl. 428/457; 428/472.2; 427/178

(57) ABSTRACT

A lighting sheet including an aluminum sheet with a substantially uniform, non-directional roll textured surface having an extended surface area (Ra roughness of about 15 to about 35 microinches) and a clear polymer layer not containing added particulate matter coated on the textured surface. The non-directional roll textured surface provides a uniform matte finish to the lighting sheet.

### BACKGROUND OF THE INVENTION

1. Field of the Invention

The present invention is directed to an aluminum alloy sheet product for lighting sheet with a diffuse appearance and a highly reflective surface, more particularly, to a lighting sheet produced from roll textured aluminum sheet product.

2. Prior Art

Lighting fixture components, such as louver structures having reflective parabolic or other curved surfaces, have conventionally been produced from anodized aluminum sheet. Anodized aluminum has been an effective material for manufacture of reflective lighting fixture components due to its optical qualities and formability into the shapes necessary for use in reflective lighting fixture components. Of particular interest in the marketplace are semi-specular (matte finish) reflective lighting fixture components. As used herein, the phrase “total reflectance” refers to the amount of incident light striking a surface that is reflected in all directions and the phrase “highly reflective” refers to a surface which reflects 80% or more light. The term “specular reflectance” refers to reflectance measured at an angle which is equal to the angle of incidence. A matte or semi-specular finish is defined as an appearance which has a specular reflectance of less than 40% measured at 30° from normal incidence light according to ASTM E-430.

Conventional lighting sheet product is manufactured by polishing aluminum sheet to produce a highly reflective surface via chemical polishing or electropolishing, both generally carried out in an acidic bath. After polishing, the surface must be treated again to render it resistant to corrosion. Corrosion resistance has generally been imparted to aluminum alloy surfaces by anodizing the surfaces to produce an anodic oxide layer followed by sealing the anodic oxide layer.

Anodizing processes have been practiced commercially on aluminum lighting sheet products for several years. Although anodized surfaces are chemically stable and resistant to corrosion, the processes are expensive. In addition, anodized aluminum alloy surfaces are often subject to iridescence and to oxide crazing during subsequent forming or exposure to elevated temperatures.

More recently, matte finish lighting sheet has been produced from highly reflective aluminum sheet as described in U.S. Pat. No. 5,985,040, incorporated herein by reference. The sheet may be bright finished to a surface roughness of about 0-3 microinches or may be mill finished to a surface roughness of 4 to 8 microinches or up to less than 15 microinches. The sheet is then coated with a polymer layer containing light diffusing particulates which create a matte appearance in the final product. Alternatively, a matte appearance may be produced by etching the bare aluminum sheet in a caustic (alkaline) solution.

Each of these routes to producing matte finish lighting sheet has drawbacks. Mill finished aluminum sheet and conventional roll textured aluminum sheet (both with directional roll grind) and etched sheet have inherent nonuniformities in distribution of roughness features which result in non-uniform light reflection. For bright finished sheet, uniform doping of the polymer layer with light diffusing particles likewise can be difficult to accomplish. In addition, bright finishing of aluminum sheet adds significantly to the cost of the final product.

Accordingly, a need remains for a method of producing matte finish lighting sheet product which avoids the need for doping the polymer layer of lighting sheet with particulates and avoids the expense of producing bright finished sheet, yet consistently and uniformly produces an aluminum sheet which, when coated with a polymer layer, exhibits sufficient non-specular reflectance.

### SUMMARY OF THE INVENTION

This need is met by the lighting sheet of the present invention which includes an aluminum sheet having a substantially uniform, non-directional roll textured surface with an extended surface area and an Ra roughness of about 15 to about 35 microinches or more preferably about 20 to about 25 microinches. The textured outer surface is produced by rolling the aluminum sheet with at least one roll textured by electron discharge texturing, laser texturing, electron beam texturing, mechanical texturing, chemical texturing, or electrochemical texturing. The extended surface area is extended from about 1 to about 50%. A ratio of a with-the-grain Ra to a cross grain Ra is about 0.7 to about 1.3. When citing a range of surface area extension or roughness or other ranges described herein, the range includes all intermediate levels such as surface roughness of 15 to 35 microinches including a surface roughness of 16, 17, or 18 microinches on up through and including the end of the range. The textured surface is conversion coated and covered with a polymer layer of a polyester or an acrylic polymer or both at a thickness of about 0.3 to about 0.7 mil. The polymer may be coated onto the textured, conversion coated surface with a curable polymer dispersed in a liquid vehicle. The liquid vehicle is evaporated and the polymer coating is cured on the textured outer surface. No light-diffusing dopant particles are needed. Hence, the coating of the polymer contains no additional particulate matter.

The aluminum sheet may be about 0.01 to about 0.03 inch thick and composed of an aluminum alloy of the AA 1000, 3000, and 5000 series, such as AA 1050, 1100, 3003, 5005, 5050, 5052, 5053, or 5657.

### DETAILED DESCRIPTION OF THE INVENTION

The present invention includes a lighting sheet and a method of making the same. In its most basic form, the lighting sheet of the present invention includes a roll textured, aluminum alloy sheet having a reflective surface with substantially non-directional roughness that is protected by a conversion coating and a polymer coating.

Aluminum sheet material of the invention is preferably made from an aluminum alloy. As used herein, the term “aluminum alloy” refers to an alloy containing about 90% or more aluminum, and one or more alloying elements. when alloying is necessary for mechanical performance, the preferred alloying elements are magnesium, usually comprising about 0.5 to about 10 wt. % of the alloy, and manganese, usually provided at about 0.15 to about 2 wt. % of the total alloy. Various aluminum alloys in sheet form are suitable for the practice of the present invention, including the alloys of the 1000, 3000, 5000 series (Aluminum Association designations). Appropriate tempers include H1x, H2x, H3x, and O-tempers (Aluminum Association designations). Aluminum-magnesium alloys of the AA 5000 series are preferred, especially the AA 5000 series alloys containing about 15 wt. % or less magnesium.

Some suitable compositions include the 1050, 1100, 1085, 3003, 3004, 3005, 5005, 5050, 5052, 5252, and 5657 aluminum alloys (Aluminum Association series). The AA 5005 alloy contains about 0.5-1.1 wt. % Mg, 0.07-0.30 wt. % Si, 0.10-0.7 wt. % Fe, 0.03-0.20 wt. % Cu, 0.20 wt. % max. Mn, 0.10 wt. % max. Cr, 0.25 wt. % max. Zn, 0.15 wt. % max. other alloying elements and impurities, and remainder Al. The alloy may contain about 0.65-0.80 wt. % Mg, 0.07-0.09 wt. % Si, 0.10-0.17 wt. % Fe, 0.03-0.06 wt. % Cu, 0.010 wt. % max. Mn, 0.05 wt. % max. Cr, 0.10 wt. % max. Zn, 0.10 wt. % max. other alloying elements and impurities, and remainder Al. The sheet may be about 0.01 to about 0.03 inch thick.

The aluminum sheet used in the present invention alloy is a roll textured aluminum alloy having an Ra value of about 15 to about 35 microinches or more preferably about 20 to about 25 microinches. The ratio of Ra in the rolling direction to the Ra in the cross-rolling direction is about 0.7 to about 1.3. The roll textured aluminum alloy is preferably produced according to the method disclosed in U.S. Pat. No. 6,290,632, incorporated herein by reference.

Roll texturing may be accomplished with a roll having an outer surface roughened via electron discharge texturing (EDT), laser texturing, electron beam texturing, mechanical texturing, chemical texturing, electrochemical texturing, or combinations thereof Suitable mechanical texturing techniques include shot peening and brush graining. In EDT, a plurality of arc generating electrodes is spaced from the outer surface of the roll and pulses of electron arcs are discharged against the roll outer surface. The arcs provide a generally uniform roll surface of peaks and valleys of desired dimensions. The electrodes rotate and traverse across the roll outer surface. The dimensions are controlled at least in part by the voltage level and the current level of the arcs, the length of the arc pulses, the length of time between arc pulses, and the electrode rotational speed and traverse rate. Electron discharge texturing is disclosed in U.S. Pat. Nos. 3,619,881 and 4,789,447, both being incorporated herein by reference. The roughness value (average distance of valley to peak of the roughened surface referred to as Ra) is an important parameter for the determination of the kind of texture that has been imposed on the roll.

The texture of the treated roll preferably has a substantially uniform topography which imparts a substantially uniform topography in the rolling and cross-rolling directions of the sheet such that in the sheet, a ratio of the Ra in the rolling direction to the Ra in the cross-rolling direction is about 0.7 to 1.3, as described in U.S. Pat. No. 6,290,632.

Typically, the roll is comprised of an iron derived alloy, usually steel and any one of the alloys thereof Extending the surface of the treated roll increases the surface area of the roll to about 0.05 to about 50%, or about 1 to about 50%, or about 10 to about 50% when compared to an untreated roll. The increase in the surface area is substantially orthogonal to the length of the roll. An untreated roll typically has elongated troughs. By texturing the roll, submicron sized craters and/or indentations are created and the negative image thereof can subsequently be transferred at least in part to the surface of the sheet thereby increasing (extending) the overall surface area and the working surface area of the sheet. Treated rolls are generally initially plated and then textured. Roll plating is achieved by electrochemical, chemical, thermomechanical, or mechanical plating; plating by sputter deposit; vapor deposition; and combinations thereof The plating may be in a single or plurality of layers. The preferred plating is electrochemical in one or more layers. Plating metals comprise nickel, chromium, cobalt, and tungsten or some combination thereof It is preferred to use chromium. The plating layers range from 0.01 to about 20,000 microns, preferably about 0.01 to 100 microns (0.39 to 3,937 microinches), more preferably 0.1 to 50 microns (3.9 to 1,968 microinches), and most preferably 1 to 20 microns (39 to 787 microinches).

After the roll has been treated, the roll is placed in a roll set. Typically two rolls are placed in a roll set opposing one another. The roll set may have one treated roll and an opposing untreated roll, or optionally may have two treated rolls opposed to each other. A roll set may be a stand alone operation or may have a plurality of roll sets placed in series. The treated rolls communicate with the metal and metal alloys through reduction and/or through simply texturing and surface modification. Reduction is an optional but highly useful operation. Reductions may range from about 10 to about 40%, or about 20 to about 30%.

It has been found that a single pass through a mill having the textured roll is capable of ridding the sheet of a substantial portion of roll grind. However, from time-to-time it is found that a single pass may affect a surface devoid of bias; the first pass itself may create nonuniformity evidenced by optical striping, rolling blemishes, and discrete areas that lack texture. Therefore, in certain circumstances it is preferred to make at least two passes through the roll set to obtain the desired texture. More than two passes can be made, but this increases the cost of each sheet.

When textured rolls, for example rolls subjected to EDT, are used to roll the sheet, the surface area of the sheet is increased (extended) in a substantially non-directional manner to a final thickness of about 0.01 to 0.03 inch. The surface area of a nominally flat aluminum sheet (mill finished) which is roll textured according to the present invention is extended by about 1 to about 50%. The surface roughness (Ra) of aluminum sheet rolled with EDT treated rolls may be about 15 to about 35 microinches or about 20 to about 25 microinches. The resulting non-directional textured surface provides a more diffuse surface than a mill finished surface with concomitant higher uniformity in the surface yet with a total reflectance of greater than about 70%. Roll grind (directionality) present in lighting sheet produced from mill finished sheet or conventionally roll textured sheet is detrimental to the final product quality. When the roll direction is visible, the sheet must be cut in one direction so that when the lighting fixture components are in place, the components appear uniform. This significantly impairs the ability to cut aluminum sheet in various orientations and results in excessive waste. The substantially uniform, non-directional textured surface of the product of the present invention improves the uniformity of lighting fixture components incorporating the product of the present invention.

Following roll texturing of the aluminum alloy sheet, a conversion coating is applied in order to assure good adhesion of the polymer coating and improved corrosion resistance of the final product. Both chrome-containing and chrome-free conversion systems are suitable. The chrome conversion coating generally contains a chromate and a phosphate. Some known non-chromate conversion coatings are solutions containing zirconate, titanate, molybdate, tungstate, vanadiate, and silicate ions, generally in combination with hydrogen fluoride or other fluoride compounds.

The conversion coated sheet may be rinsed and then dried thoroughly before it is spray coated or roll coated with a solution of a curable, clear polymer, such as a polyester or an acrylic polymer or both. Some suitable polymers include polyesters, such as polyethylene terephthalate (PET) and polybutylene terephthalate (PBT), polyurethanes, polyvinyl chloride, nylon, polyolefins, and various acrylics which are stable upon long-term exposure to ultraviolet (UV) radiation. A UV-stable polyester is particularly preferred. When a highly reflective finish is desired, the UV-stable polymer is preferably a polyester or acrylic that does not substantially diminish surface brightness. The polymer layer does not contain any added particulate matter to alter its appearance or light reflective properties.

The polymer coating is preferably dissolved in organic solvents, such as methyl isobutyl ketone (MIBK) or methyl ethyl ketone (MEK) or butyl cellosolve, for example, in a concentration of about 35 wt. %. The solution is preferably roll coated or sprayed onto the sheet to produce a cured coating thickness of about 0.3 to 0.7 mil. The polymer-coated sheet is heated in an oven to cure the polymer. The sheet will reach a peak cure temperature of about 400° to 500° F.

It will be readily appreciated by those skilled in the art that modifications may be made to the invention without departing from the concepts disclosed in the foregoing description. Such modifications are to be considered as included within the following claims unless the claims, by their language, expressly state otherwise. Accordingly, the particular embodiments described in detail herein are illustrative only and are not limiting to the scope of the invention which is to be given the fill breadth of the appended claims and any and all equivalents thereof

We claim:

1. A lighting sheet comprising:
an aluminum sheet having a substantially uniform, non-directional roll textured surface with an extended surface area and an Ra roughness of about 15 to about 35 microinches; and
a coating layer positioned on said textured surface, said coating layer consisting essentially of a clear polymer.

2. The lighting sheet of claim 1, wherein a ratio of a with-the-grain Ra to a cross grain Ra is about 0.7 to about 1.3.

3. The lighting sheet of claim 1, wherein the Ra roughness of said aluminum sheet is about 20 to about 25 microinches.

4. The lighting sheet of claim 1, wherein said extended surface area is extended from about 1 to about 50%.

5. The lighting sheet of claim 1, wherein said aluminum sheet comprises an aluminum alloy selected from the group consisting of the AA 1000, 3000, and 5000 series.

6. The lighting sheet of claim 1, wherein said aluminum sheet comprises an aluminum alloy selected from the group consisting of AA 1050, 1100, 3003, 5005, 5050, 5052, 5053, and 5657.

7. The lighting sheet of claim 1, wherein said aluminum sheet is about 0.01 to about 0.03 inch thick.

8. The lighting sheet of claim 1, wherein said polymer layer comprises a polyester or an acrylic polymer or both.

9. The lighting sheet of claim 1, wherein said polymer layer is about 0.3 to about 0.7 mil thick.

10. The lighting sheet of claim 1, where said lighting sheet has a total reflectance of greater than about 70%.

11. A process for making an aluminum sheet product having a reflective surface, comprising:
a) providing an aluminum sheet having a textured surface having an extended surface area and a substantially uniform, non-directional surface roughness resulting from rolling the sheet with at least one textured roll, said surface having an average surface roughness Ra of about 15 to about 35 microinches,
b) chemically conversion coating said textured surface; and
c) coating the textured, conversion coated surface with a coating layer consisting essentially of a clear polymer.

12. The process of claim 11, wherein step c) comprises coating the textured, conversion coated surface with a curable polymer dispersed in a liquid vehicle, evaporating said liquid vehicle, and curing the polymer coating on the textured outer surface.

13. The process of claim 1 1, wherein a ratio of a with-the-grain Ra to a cross grain Ra is about 0.7 to about 1.3.

14. The process of claim 11, wherein said textured surface has an average surface roughness Ra of about 20 to about 25 microinches.

15. The process of claim 11, wherein said textured outer surface is produced by rolling the aluminum sheet with at least one roll textured by electron discharge texturing, laser texturing, electron beam texturing, mechanical texturing, chemical texturing, or electrochemical texturing.

16. The process of claim 11, wherein the extended surface area is extended by about 1 to about 50%.

17. The process of claim 111, wherein the aluminum sheet comprises an aluminum alloy selected from the group consisting of the AA 1000, 3000, and 5000 series.

18. The process of claim 11, where the aluminum sheet comprises aluminum alloy selected from the group consisting of AA 1050, 1100, 3003, 5005, 5050, 5052, 5053, and 5657.

19. The process of claim 11, wherein the aluminum is about 0.01 to about 0.03 inch thick.

20. The process of claim 11, wherein the polymer comprises a polyester or an acrylic polymer or both.

21. The process of claim 11, wherein the polymer coating is about 0.3 to about 0.7 mil thick.

22. The process of claim 11, wherein said aluminum sheet product has a total reflectance of greater than 70%.
